(19) United States
(12) Patent Application Publication
(10) Pub. No.: US 2018/0101508 A1
(43) Pub. Date: Apr. 12, 2018

(54) SYSTEM METHOD AND APPARATUS FOR ENTRY AND DISPLAY OF REFERENCE DATA IN THREE AXES

(71) Applicants: Olivier Marie Joël Venard, Jerusalem (IL); Kevin Stephens, Jerusalem (IL)

(72) Inventors: Olivier Marie Joël Venard, Jerusalem (IL); Kevin Stephens, Jerusalem (IL)

(21) Appl. No.: 15/290,701

(22) Filed: Oct. 11, 2016

(51) Int. Cl. G06F 17/22; G06F 17/24

(52) U.S. Cl. CPC G06F 17/2288; G06F 17/2745; G06F 17/241

(57) ABSTRACT

A comprehensive system, method, and apparatus of digitally researching, organizing, creating content and displaying biblical data according to the main versions of the Bible together and three axes (Text, Context, and Reception) encompassing most of the human sciences connected with the Bible, subdivided in many different Rubrics.

### BACKGROUND OF THE INVENTION

The present invention relates to systems, methods and apparatus for the entry and display of research data appended or annotated to a scientific or literary work and, more particularly, to the entry of reference data to a present bible.

Biblical translations into modern languages have historically ignored the richness of irreducible versions of the Scriptures. The tendency has been to use one of a chosen Urtexte (i.e. original text) as the one true foundation upon which the translation is to be made and to more-or-less ignore the others. During the 20th century and continuing into the 21st century, many discoveries have been made and continue to be made that demonstrate the richness of the eco-system of biblical versions in several languages from their earliest days.

Since the 1960s human sciences disciplines have been stressing the importance of the (communities of) readers in determining the varied meanings of a given text. As such, biblical annotation must encompass the reception history of the Scriptures.

While many platforms for biblical research exist, there is no platform that allows an individual to both research and consult, in a modern language, biblical data in the fullness of its various linguistic traditions.

As can be seen, there is a need for a comprehensive platform on which to build a solution for researching and presenting the biblical texts in their multiple versions and their reception according to their varied, multilayered, interdisciplinary complexity.

### SUMMARY OF THE INVENTION

In one aspect of the present invention a system for digitally researching, organizing and displaying data relating to a primary work, includes: a computer having a user interface; and a program product comprising machine-readable program code for causing, when executed, the computer to perform the following process steps: producing an electronic representation of a portion of the primary work in a first column of a display area responsive to a user specified scope; producing an electronic representation of a note in a second column of the display area, the note corresponding to the portion of the primary work in the first column and organized according to a first category of rubrics; and producing an electronic representation of the note in a third column of the display area, the note corresponding to the portion of the primary work in the first column and organized according to a second and a third category of rubrics. The steps also include dynamically updating the electronic representation of the portion of the primary work responsive to a user specified change in the scope; and dynamically updating the electronic representation of the note responsive to the user specified change in scope.

In other embodiments, the process steps include producing an electronic representation of a marginal reference corresponding to the portion of the primary work in the first column, within intertextual reference zone of the display area; and dynamically updating the electronic representation of the marginal reference responsive to the user specified change in scope. A control with the marginal reference may also be included and is operable to select a referenced portion of the primary work.

The display area may also be configured to produce an electronic representation of a recommended reading zone presenting references corresponding to a selected rubric; and to dynamically update the recommended reading zone responsive to the user specified change in scope.

In other embodiments of the invention, the electronic representation of the portion of the primary work is presented in a plurality of versions, wherein each version is designated by a visual indicia corresponding to each version. The visual indicia may be a head letter.

The system is preferably configured such that the note is prefaced with a citation to the portion of the primary work in the first column. The note may have a control that is operable to present an electronic representation of the note.

In other embodiments, the system may be configured to present a control area having a plurality of controls for receiving a user input specifying the scope. The plurality of controls may include: a slider, a scroll direction control, a search window, and a menu indicator control. An optional control, operable in the control area may activate a content creation module, configured for a contributor to create one or more of a note, a synthetic note, or a marginal reference.

Yet other aspects of the invention include: a non-transitory machine storage medium having stored thereon a computer program for digitally researching, organizing and displaying data relating to a primary work, the computer program comprising a set of instructions for causing the machine to perform the steps of: producing an electronic representation of a portion of the primary work in a first column of a display area responsive to a user specified scope; producing an electronic representation of a note in a second column of the display area, the note corresponding to the portion of the primary work in the first column and organized according to a first category of rubrics; and producing an electronic representation of the note in a third column of the display area, the note corresponding to the portion of the primary work in the first column and organized according to a second and a third category of rubrics; The steps include dynamically updating the electronic representation of the portion of the primary work and the note responsive to a user specified change in the scope. In other embodiments, the steps include producing an electronic representation of a marginal reference corresponding to the portion of the primary work in the first column, within an intertextual reference zone of the display area. The intertextual reference zone is dynamically updated with the electronic representation of the marginal reference responsive to the user specified change in scope. A control with the marginal reference may be operable to select a referenced portion of the primary work.

The steps may further include, producing an electronic representation of a recommended reading zone which presents references corresponding to a selected rubric; and includes dynamic updates to the recommended reading zone responsive to the user specified change in scope.

In yet other embodiments, the electronic representation of the portion of the primary work is presented in a plurality of versions, where each version is designated by a visual indicia corresponding to the version.

These and other features, aspects and advantages of the present invention will become better understood with reference to the following drawings, description and claims.

### BRIEF DESCRIPTION OF THE DRAWINGS

FIG. 1 is a flowchart depicting an Administrator module for managing Contributors.

FIG. 1A is a control for selecting Administrator Options in the Administrator module.

FIG. 1B is a UI control for receiving information for a Contributor in the Administrator module.

FIG. 1C is a UI control for assigning a Contributor Role in the Administrator module.

FIG. 1D is a UI control for setting a Contributor's biblical book permissions in the Administrator module.

FIG. 1E is a UI control for setting a Contributor's Rubric permissions in the Administrator module.

FIG. 2 is a flowchart for creating or editing a note according to aspects of the invention.

FIG. 2A is an embodiment of a text editor for creating and editing a Note.

FIG. 2B is an embodiment of a UI control for determining a Scope.

FIG. 2C is a control for selecting a Rubric.

FIG. 2D is a control for selecting an Audience.

FIG. 2E is a control for selecting a Lemma

FIG. 2F is a control for creating a Title.

FIG. 2G is a control for composing a Note

FIG. 3 is a flowchart for editing text according to aspects of the invention.

FIG. 4 is a flowchart for utilizing a Best Bible user interface.

FIG. 5 is an embodiment of a user interface for a read the Bible mode.

FIG. 6 is an embodiment of a user interface for a study the Bible mode.

FIG. 7 is an embodiment of a representative system architecture.

### DETAILED DESCRIPTION OF THE INVENTION

The following detailed description focuses on the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system method and a platform that allows individuals to both research and consult biblical data in the fullness of their traditions.

According to aspects of the invention, the inventors have been able to organize the chief elements of most situations and research paths for Scriptural research and study into a simple yet comprehensive system of Categories and interrelated Rubrics. This organization offers a new standard that clarifies and organizes the technical aspects of biblical research. It facilitates the organization of vast amounts of research data into easily manageable units. This also minimizes polemical interference by offering a standard for presenting diverse points of view.

The system arranges various biblical traditions into a polyphony of simultaneous translations. It also arranges biblical notes and commentaries into an intricate matrix of rubrics that allow users to pursue a methodical analysis of Scripture in all its facets.

Other aspects of the invention include an innovative database system to manage these various ways of annotating Scripture and with the system acting as a central hub that connects both a Contributor interface and a Consultation interface through the same rigorous system. Individual Contributors working as globally dispersed research laboratories, may submit content, which is reviewed using the same system by other Contributors according to expertise in various domains/rubrics. The system is configured to manage an editorial process which shepherds Contributor content creation from initial input through the final phase of publication.

Lexicon

As used herein the following definitional terms are provided for an understanding of the present invention.

Access Role: An Access Role represents the extent of a decision-making power that may be attributed to a contributor by an administrator of the site. Access roles are represented according to the following hierarchy:
Administrator>Contributor>Scribe

Administrator: A person responsible for managing research teams and granting each researcher permissions: on a given corpus (biblical book/s); in selected rubrics of notes; and the *saving possibilities

Audience: Any contributor, while composing a note, is invited to define the readership aimed at by that note:
Public: mass audience>General: educated people>Scholarly: scholars

Biblical Reference: A Biblical Reference is a code or sequence of codes that is utilized to locate a citation in the Bible. The Biblical References are provided in a scientific format, in which the format may be based on a selected language that is utilized to interface with the system. By way of example, a Biblical Reference in English is coded according to the following format:
The English abbreviation of a book's name, followed by a space character, followed by the Chapter number, a colon character (:), followed by the Verse(s) Number. Accordingly, the Biblical Reference, Hos 1:1, refers to the first verse of the first chapter of the book of Hosea.
   For the French language, a Biblical Reference is coded according to the following format:
The French abbreviation of the book, followed by a space character, the Chapter Number, followed by a comma character (,), followed by the Verse(s) Number. Accordingly, in French the Biblical Reference, Os 1,1, refers to the first verse of the first chapter of the book of Hosea.

Category: Categories structure and divide the rubrics into three distinct parts:
Text; Context; and Reception.

Column: a column of biblical text. When the differences between the *versions of the biblical text are so numerous that adducing them as simple variants in one single body of text would create a too complicated, unreadable text, its is better to translate each version on its own, and divide the body of text in two or three columns, one for each version or group of versions.

Contributor: Any scholar or research assistant invited by the administration of the project to contribute note in one or more *rubric.

Cross-reference: a reference from one note to any other note.
On the printed products it is presented thus : *xxx00:11:
This representation is a format for a reference from one Note to another Note, where xxx indicates the Rubric to be consulted (usually the first 3 letters of its name : *lit=liturgy; *dev=literary devices, a.s.o.), and 00:11 provide a reference to the chapter and verse, if and only if it is different from that of the Note in which the reference is inserted.

Edition: Edition refers to a presentation, a reproduction or commercialization of a specific translation of the bible. For example the King James Version of the bible would be representative of an Edition.

Lemma: A Lemma is a literal citation of a word or a set of words that are being discussed in the annotation on a specific passage of text.

Lemmatized Mode: The Lemmatized Mode is a layout that allows a reading of the *scroll of the Bible with one or more notes positioned to the sides of the Bible text to which the notes correspond or refer.

Marginal Reference: A Marginal Reference is an intertextual reference to another biblical passage.

Note: A Note is a Commentary on a specific portion of a work, in the context of the Bible, a biblical passage of text.

Pericope: A Pericope is a set of verses that form a coherent unit of verses.

Primary Work: a work of authorship or a body of literary or technical works of authorship. In the context of biblical research, an example would be a set of 11 different translations or traditions of biblical texts that can be studied side by side within the system of the present invention, including for example:
1. Reyna Valeira
2. King James Version
3. Crampon
4. Bible de Jerusalem
5. New Jerusalem Bible
6. New American Bible Revised
7. Massoretic Text
8. Septuagint
9. Samaritan Pentateuch
10. Vulgate
11. Peshitta

Rubric: A Rubric is a method or structured approach to the organization or characterization of a Note into different themes based upon the Note's content.
There are 26 Rubrics, which are structured within the three *Categories:
Rubrics within the Text Category include: Textual Criticism; Vocabulary; Grammar; Literary Devices; and Literary Genre.
Within the Context Category, the Rubrics include: Historical and Geographical Notes; and Ancient Cultures.
Finally, the Rubrics within the Reception Category include: Synoptic Reading; Comparison of Versions; Biblical Intertextuality; Peritestamental Literature; Liturgies; Law; Jewish Tradition; Christian Tradition; Mysticism; Theology; Philosophy; Psychoanalysis; Islam; Literature; Visual Arts; Music; Dance; and Cinema.

Saving possibilities: Notes may be saved reflecting a progression in the promulgation and publication of a Note in the system, based upon the Contributor's choice. The Contributor may choose one of the following selections:
Draft; Submit; Approve; and Publish.
   Draft: Saving a Note as a Draft may be utilized when the Note is unfinished and the Contributor would like to revise the note after further research or reflection on the note. A Draft Note remains invisible to anyone other than the Contributor that authored the Note.
   Submit: When a Contributor wishes to have other Contributors view an unfinished Note, they may choose to Submit the Note. When a note is Submitted, the Note remains, it is marked as unfinished to alert other Contributors to its status, but the Note is now visible to other Contributors. This option may be selected, for example, when the submitting Contributor wishes to receive commentary or feedback from other Contributors.
   Approve: After a period of commentary, and possible revision by the Contributor, the Contributor may then choose to advance the Note and save the Note as Finished. A Finished Note is also visible to other contributors and may display a finished status to the other Contributors. While a finished Note remains changeable (by any authorized *Contributor), the status represents an indication that the submitting Contributor considers the Note to be in a final condition.
   Publish: visible to everyone. Only the administrators may publish.
According to the permissions granted to the contributors, the whole process from draft to publish may be reiterated (i.e. a published note may be re-submitted). This possibility allows to constantly update the works produced by the invention even after they have been released.

Scope: Scope refers to a citation or specified range of citations to a portion of a work, in the context of the Bible a Biblical Reference (e.g. Gn 1:1) or range of Biblical References (e.g. Gn 1:1-5.

Scribe: One of the *access roles. A scribe is a research or editing assistant authorized to access the workspace and work under the name of a specific contributor.

Scroll: Scroll refers to the layout used to present to the public the Bible and its different versions and variants. This layout provides a hint at the formats and medias that the Bible embraced at its beginnings and throughout history (scroll, glossa, book).

Slider: The slider is the tool at the bottom of the *scroll, that allows the user to quickly reach a specific passage by selecting the appropriate book and a *Pericope or Chapter.

Synthetic Note: A Synthetic Note is a Note on a subject related to in several passages of the work; it allows the Contributor to put forward the biblical intertextuality of a theme.

Title: A Title is given to each note and encapsulates of its content.

Variant: On a specified Scope, a Variant represents differences between

Versions. For Example, for the specified Scope of Hos 1:2, Variants may be presented as:
M has “When the Lord first spoke through Hosea”
S has “The beginning of the word of the Lord that was to Hosea”
V has “At the beginning of Lord's speaking through Hosea”
G has “The beginning of the word of the Lord in Hosee”.
   In the foregoing, the Version is indicated by a letter abbreviation for a Version, followed by a quotation of the biblical text specified by the Scope.

Version: A Version is a particular textual form in which the Bible has been transmitted-translated. The most frequently used designations for the version in the BEST Bible are:
M: Masoretic Text in Hebrew and Aramaic
S: Peshitta in Syriac
Sam: the Samaritan Hexateuch
G: Septuagint in Greek
V: Vulgate in Latin
Nes: The Nestle-Aland reference critical edition of the New Testament in Greek
Byz: the Byzantine text of the New Testament in Greek
TR: The “Textus receptus” of the New Testament in Greek

I. Administrator Module

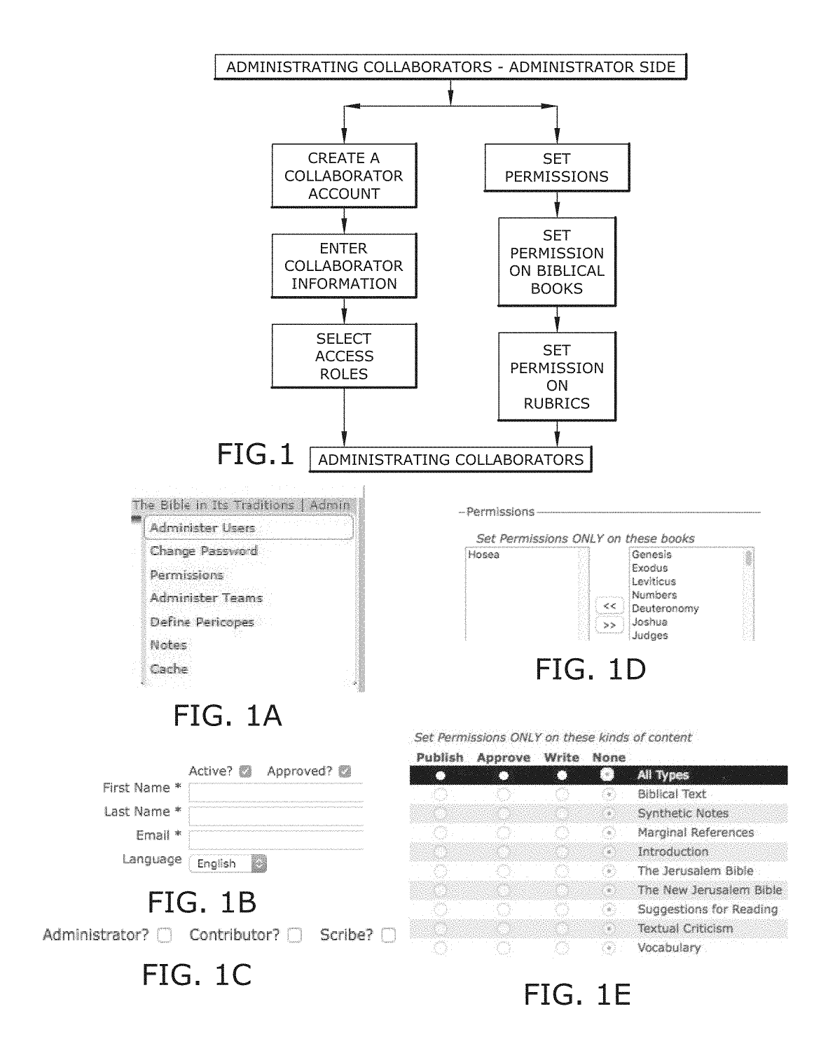

A representative embodiment of an Administrator Module is depicted in reference to FIG. 1. The Administrator Module provides an Administrator with functionality for the management and administration of one or more *Contributors that may utilize the system. An Administrator control, such as shown in FIG. 1A, permits the Administrator to select from other functionalities provided through the Administrator Module. Other functions may also include: Administer Users in the system, change a user's password, set or change Permissions to system resources, Administer Teams of Contributors, Define *Pericopes, manage *Notes, and manage Cache configurations.

In a first path, an Administrator can create a Contributor account. Once the account is created, the Administrator or Contributor may enter information pertaining to the Contributor, such as research areas, contact information etc., via a UI control shown in FIG. 1B. Next, Administrator may assign a Role to a Contributor, with a representative UI control such as referenced in FIG. 1C. In a second path, the Administrator may set access permissions for the Contributor. The Administrator may also set permissions to biblical books within the system repository, via a UI control shown in FIG. 1D. The permissions may be set according to various criteria, such as a Contributor's recognized expertise on a particular biblical text. After the books permissions are set, the Administrator may set the Contributor's permissions to the system *Rubrics. As with the books permissions, permissions to the system Rubrics may be based on selection criteria, such as a Contributor's training, scholarship, or experience within one or more Categories or Rubric classifications. In addition, the Administrator may assign permissions to assign Contributors to work on specific books or tasks based on the Administrator's needs.

II. Creating Content—Contributor Side

Content within the system may be generated through various methods. As a primary component, Content is provided within the system via the importation of electronic embodiments of the various *Versions of biblical texts, representing various linguistic translations, and traditions. At present, there are 11 different translations or traditions of biblical texts that can be studied side by side within the system of the present invention. These Primary Works may be maintained in a data storage repository 14.

As indicated previously, there is no complete solution, nor is there a comprehensive platform on which to build a solution for researching and presenting the biblical texts in their multiple versions along with its context and reception according to their varied, multilayered, and interdisciplinary complexity. This is where the system of the present invention is unique. Through the participation of a plurality of Contributors, Content may also be generated within the system via a Content Creation module.

Through the Content Creation module, the scholarly efforts of Contributors participating in the system may be captured for presentation with the Primary Works. Through aspects of the invention, the Contributor's works may be presented or supplemented to the Primary Works, through an editorial process implemented through various controls and processes within the system. Through a Contributor Content creation module, Contributors may:
create or edit a Note, including a Synthetic Note;
create or edit a Marginal Reference;
and edit a Text.

The Contributor may decide on or may be assigned a passage of Scripture, and a Rubric or set of Rubrics for his/her research. He/she enters annotations that are then managed through the database system. By allowing the Contributors to follow a rigorous system of translation and annotation, the invention makes sure that they produce a highly targeted content, immediately useful for their audience and for continuing academic research.

Notes Module

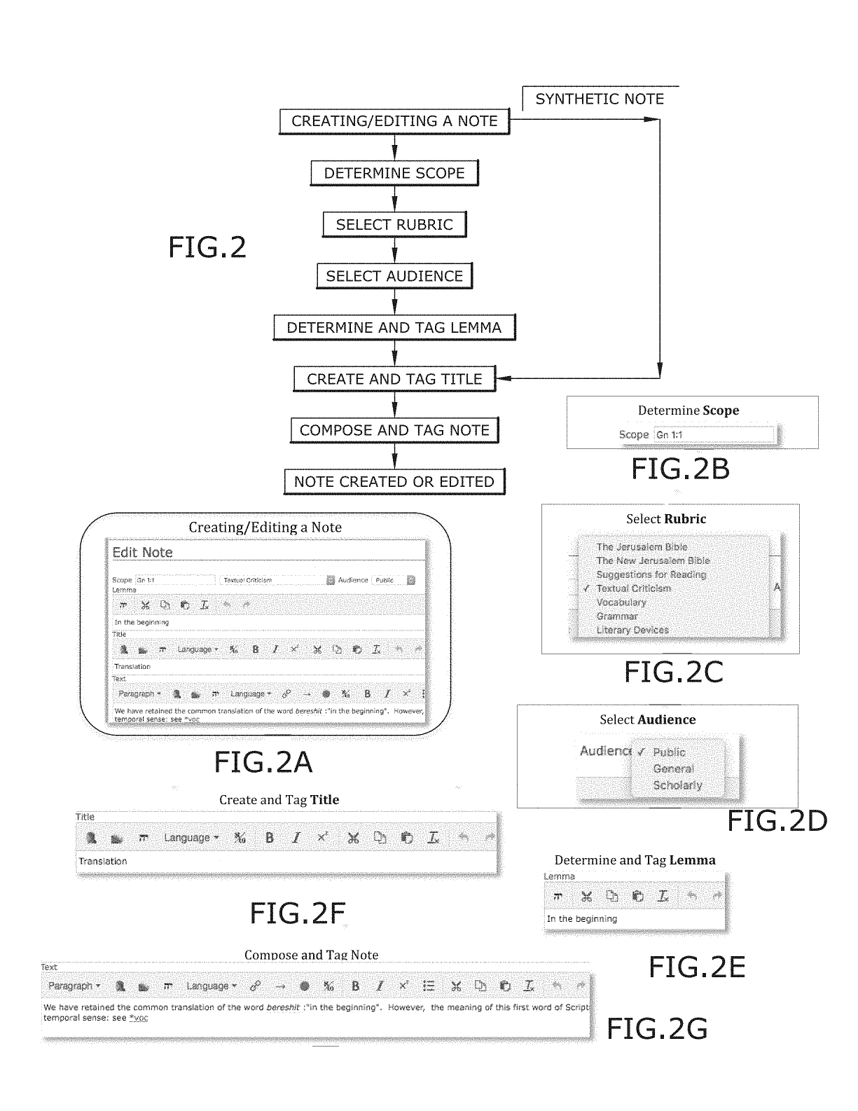

A Contributor may create or edit a Note through a Notes Module illustrated in reference to the flowchart of FIG. 2. The system presents a Create/Edit Note UI, such as that shown in FIG. 2B. To create a Note with the Notes Module, the Contributor will determine and enter a desired Scope for the Note, shown in the detail view of FIG. 2C. Once the Contributor has entered a desired Scope, the Contributor may then select one Rubric (among those he/she has been granted access to), that he/she considers appropriate for classifying or indexing the Note within the system. Rubrics may be selected via a control, such as that shown in reference to FIG. 2C. The Contributor may then select a desired or target Audience for the note, via a UI control such as shown in FIG. 2D. If the Contributor wants unlimited visibility for the note, they can select Public. If the Contributor desires to limit visibility of a note, they may choose General or Scholarly. If the Contributor desires to restrict visibility of the Note, they may choose Scholarly as the Audience. Next, the Contributor will determine and format (including tagging special contents such as transliteration of original languages, author's names or titles of books cited . . . ) a *Lemma, and the title of what will be discussed in the note, as shown in FIG. 2E. The Contributor may then use a text editor interface control, such as that in FIG. 2F to compose the contents of the Note.

A Contributor may also use the Notes module to create a Synthetic Note. In this instance, the Scope, Rubric, Audience and Lemma controls are bypassed, and the Contributor is presented the Title Create interface control. After completion of the Title, the Contributor may compose and format the Synthetic Note.

Edit Text

Edit Text consists in producing translations of the traditional versions, editing or introducing changes to the actual text of the *Primary Work.

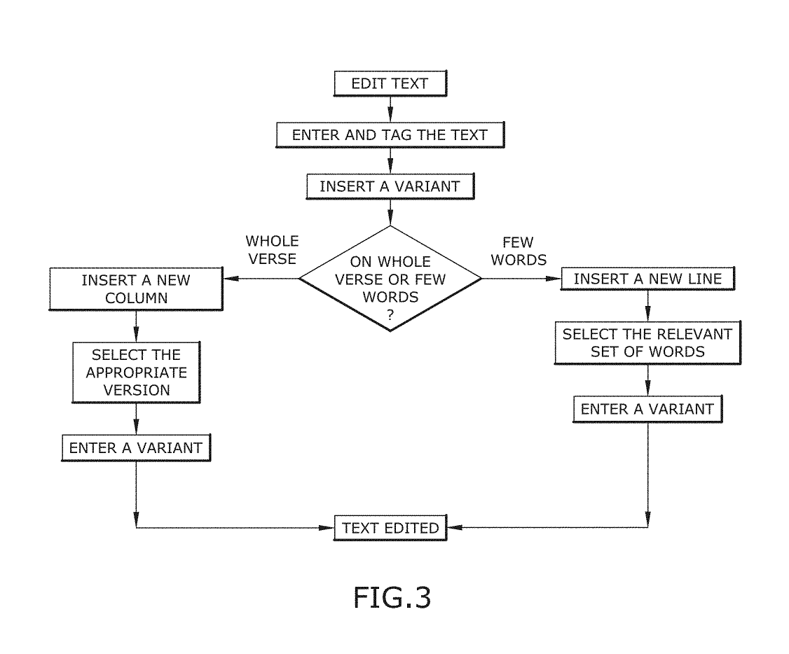

As seen in reference to FIG. 3 a Contributor may edit text of a *Primary

Work via an edit text UI. For example, those Contributors who are engaged in translation use a proprietary system where they can create parallel translations from various Traditions or adduce Variants in any of them.

The Contributor would first enter the text of a desired verse. The Contributor may then insert a *Variant of the selected text based upon choosing selected words within the verse. The Contributor would then click on the variants-button to open the Variant text entry box. The system can insert in that box as many new lines as necessary. The Contributor would then select the identifier(s) for the corresponding Version(s) for the Variant, and enter the text(s) of those variant(s). Once completed the Contributor would select the appropriate *saving Possibility for the submission.

If editing the whole verse, the editor may insert a new parallel *column presenting the given version on its own. He/she does so by clicking on the arrow next to the abbreviation of the desired *Version above the text. The Contributor would then enter the text(s) of those variant(s). Once completed the Contributor would select the appropriate *Saving Possibility for the submission.

Marginal Reference

A Contributor may also create or edit a Marginal Reference by selecting a control invoking a Marginal Reference interface. The interface permits the Contributor to enter a Title and a (string of) Biblical Reference(s) corresponding to the Title. Once completed with the Marginal Reference entry, the Contributor selects the appropriate Saving Possibility.

III. Using the B.E.S.T. Bible—User Side

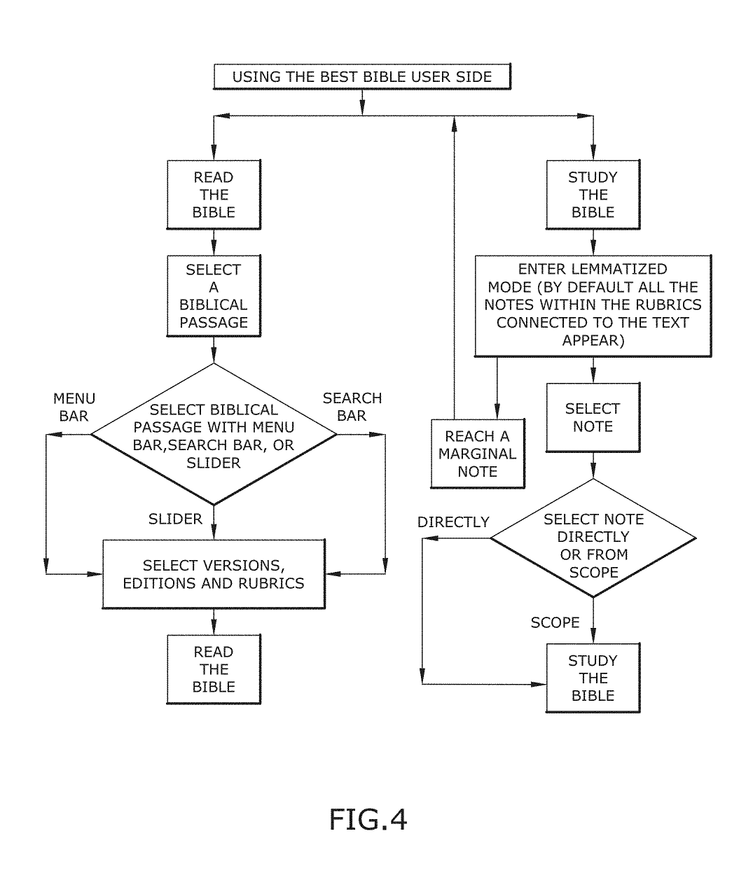

As seen in reference to FIGS. 4, a flowchart for a User Side UI for navigating and interacting with the B.E.S.T. Bible is illustrated. The UI may be utilized in a reading mode and a study mode.

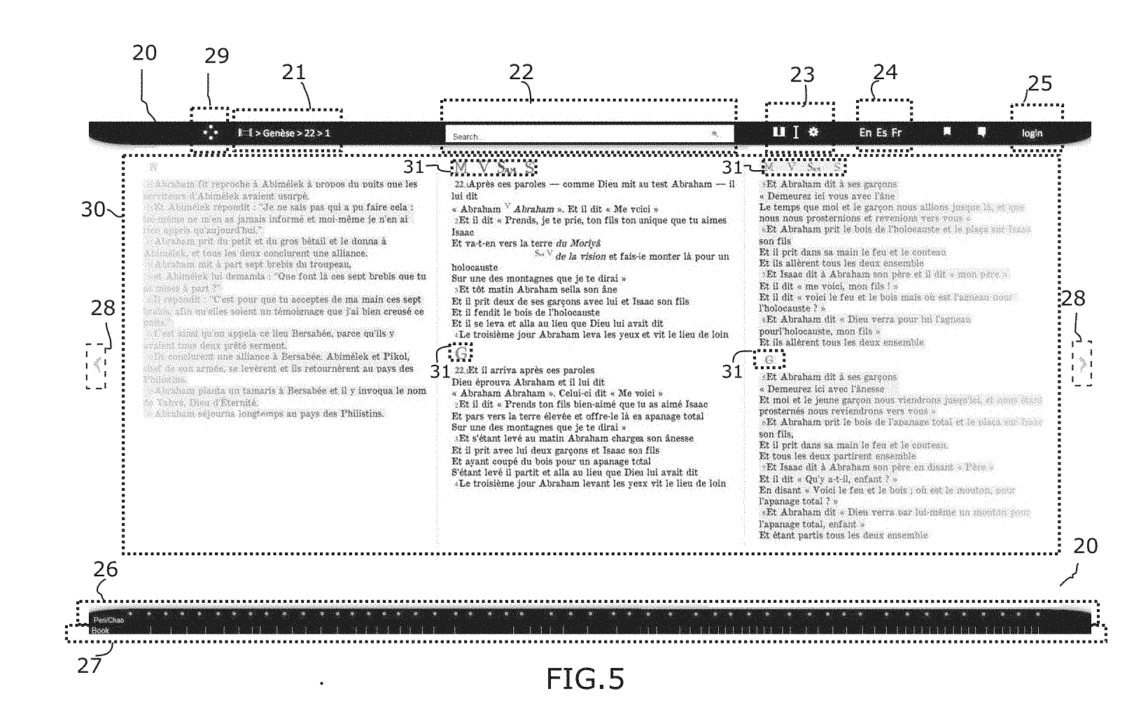

A reading mode UI is illustrated in reference to FIG. 5. The reading mode UI is subdivided into a control area 20, presented in the upper and lower bars of the display and a reading pane 30, presented in a plurality of columns across a center portion of the display screen. Referring again to the flowchart of FIG. 4, the system provides for selection of a biblical passage from one or more of a menu indicator control 21, a search control 22, or one or more slider controls 26, 27. Once a passage has been selected, the user may then select a version, edition, and a rubric by activation of an icon within a selector control group 23. After the foregoing selections, the user may read the selected text in the reading pane 30.

The control area 20 of the UI includes a reference menu indicator control 21 that allows the user to select, for example, a book, a chapter, or a verse from within the repository. The reference selection control 21 also presents a visual display of the current reference displayed in the reading pane 30.

The search control 22 may be provided to enable the user to enter one or more search terms, and is user configurable to locate the search terms within the repository, within a selected book, or chapter. The reading pane 30 may also be user configurable to present the search terms in a highlighted text, or other indicia to show a search result within the text.

As indicated, the selector control group 23 provides a plurality of control icons that permit the user to select the content displayed in the reading pane 30 from a Version, an Edition, or Rubrics. A language control group 24 may also be provided that allows the user to select the language that the content is displayed in the reading pane 30 from one of a plurality of languages.

A scroll direction control 28 is provided for directional control of the display of the selected text within the reading pane.

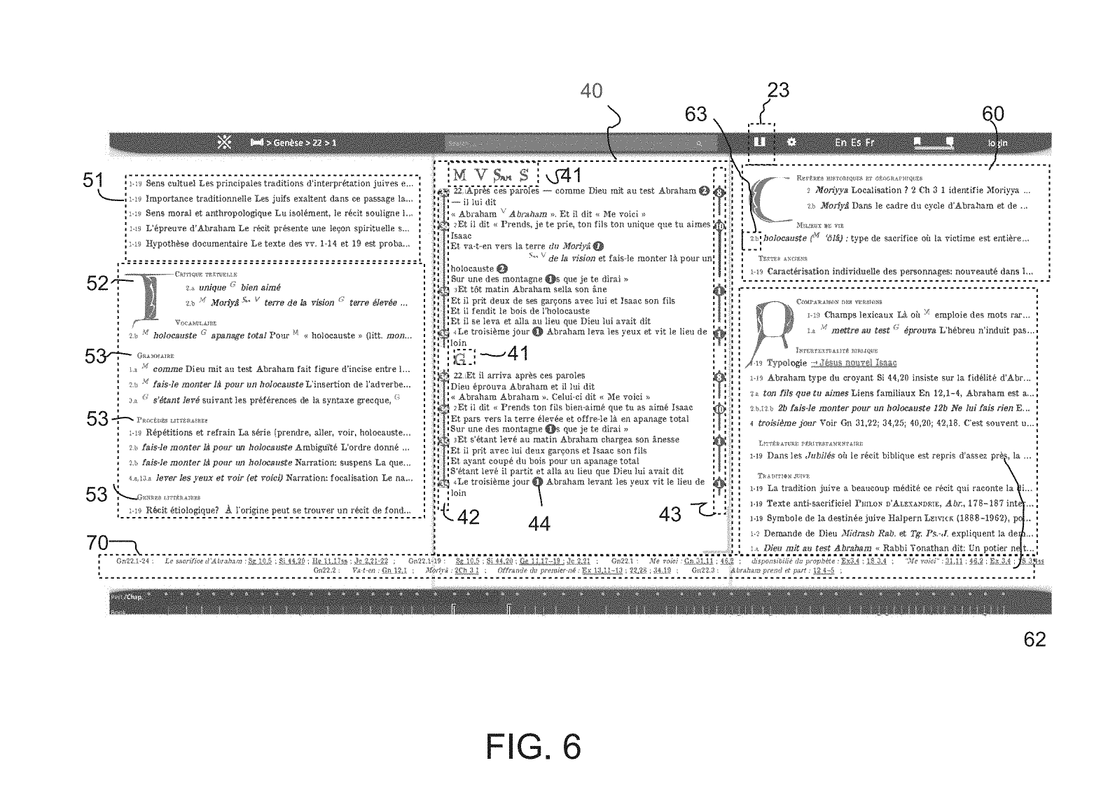

The controls described previously are available to the user for navigating a selected reference. A representative user interface for the study mode is shown in reference to FIG. 6. The display area 30 may be presented in a plurality of columns. A first column 40 presents a display of the selected text. A *Version indicator 41 is presented proximal to the displayed text. When differences in a selected text are determined to be present based in one or more *Versions, the text corresponding to each different *Version is presented following its corresponding *Version indicator 41. The Version indicator 41 may be one of an oversized stylized letter or other indicia corresponding to a name of the version.

The textual presentation of the selected verse may also include one or more flags 44 that are presented in-line with the text of a verse. The flags 44 carry a numerical count corresponding to the number of notes pertaining to the previous word or words (lemma). A first flag and indicator 42 may also be presented to one side margin adjacent to the selected chapter. The first flag and indicator 42 will similarly have a numerical count corresponding to the number of notes pertaining to the selected verse. The indicator will feature from a beginning of the selected verse and extend to an end line of the text included in the count presented in the flag portion of the flag and indicator. A second flag and indicator 43 may be presented in the opposite margin of the textual presentation. The second flag and indicator 43 will present numerical indicia of the number of notes pertaining to the verse at hand. The second flag and indicator 43 will feature between the beginning line of the selected verses to the ending line of the selected verses. In the example shown in reference to FIG. 6 , the number “35” on the flag 42 means that there are thirty-five notes pertaining to the featured chapter (here Genesis 22); the number “1” on the flag 43 means that there is one note on the apposite verse (here Genesis 22 verse 4).

Page 17 of 27

A second column in the display area 30 is utilized to present a suggested reading zone 90 pertaining to a selected rubric. The suggested reading zone 90 presents suggestions for reading, with an initial portion of the note presented to provide the user an indication of the contents of the note. Following the notes listing 90, a head letter T 52, indicating the Text category, identifies a zone for textual rubrics pertaining to the selected passage presented in the first column. Following the head letter 52, a presents the various rubrics 53 related to the text category are shown in first column. As with the note presentation, each of the rubrics 53 provide an initial portion of the contents of the note to provide the user an indication of the subject matter of the rubric.

A third column in the display area 30 may be provided to present the user with separate zones for the Context 60 and Reception 70 categories of rubrics. The zone for the Context 60 category may be indicated with a head letter C and the Reception category 70 with a head letter R. In each of the textual 50, contextual 60, and reception 60 zones, rubric names within the respective categories are presented with a listing of notes within that rubric presented in a list. The listing of notes are preceded with a reference 63 which indicates the citation to the verse to which the note pertains. The user may scroll within an individual T,C,R zone to view notes pertaining to additional rubrics, that may be included, but aren't visible.

Through the presentation zones for textual 50, contextual 60, and reception 70 categories of rubrics, the system and method of the present invention is able to provide a comprehensive method of digitally researching, organizing and displaying biblical data according to three axes of rubrics, encompassing most of the human sciences connected with the Bible, subdivided in a plurality of rubrics within each of the respective categories. As the user scrolls through or otherwise selects a desired portion of biblical text in the first column, the second and third columns are dynamically updated to present the user with an organizational structure for rapidly locating and researching notes of interest.

A marginal reference zone 80 may also be presented to include a listing of biblical intertextual references corresponding to the selected passage in the first column 40 of the display area 30. Each of the notes presented in the second and third columns, as well as the intertextual references in the marginal reference zone 80, may be selected to link the user to the full content of the notes or to link the user to the selected location specified by the marginal reference.

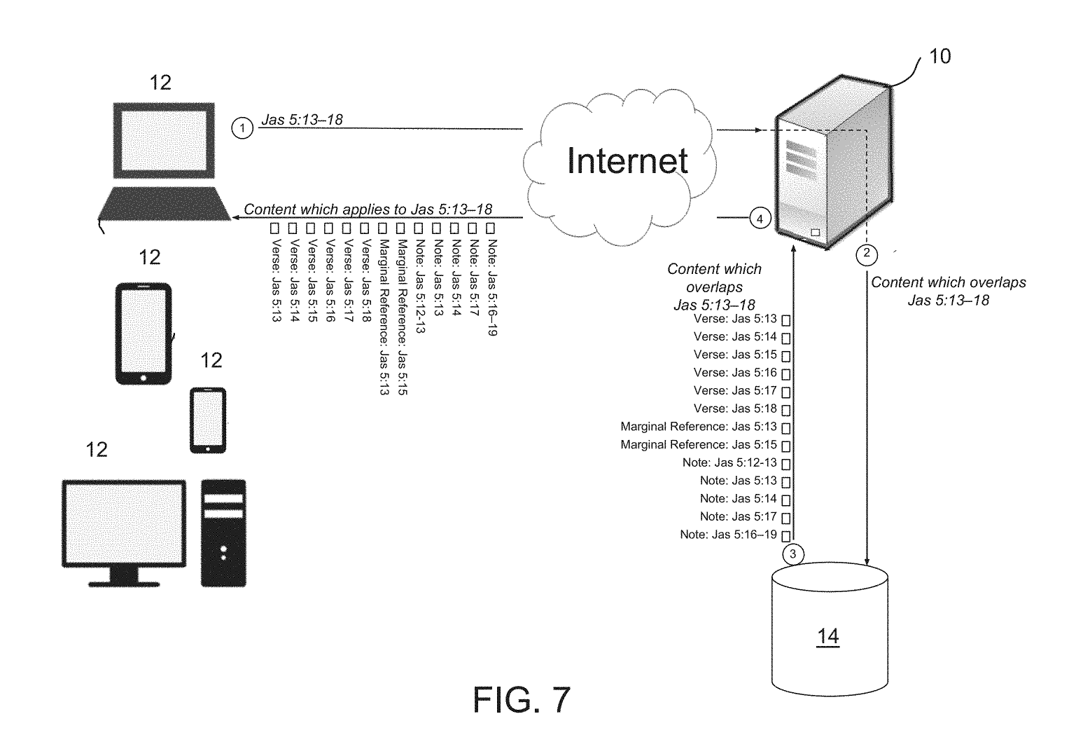

As seen in reference to FIG. 7, the dynamic updating of the display area 30 is accomplished by a client device 12 sending the selected Scope, in this case Jas 5:13-18, to an API server 10 hosting the B.E.S.T. Bible. The server 10 queries a database 14 for content which overlaps the selected scope, which includes the text of the selected verses; marginal references, and notes corresponding to the specified scope. The content is stored in the database 14 such that the content that overlaps the requested scope can be correlated. The database 14 then returns the content that overlaps the selected reference to the API server 10, which in turn, delivers it to the client device 12 for presentation in the UI. Preferably, the content for the verses Jas 5:13 through Verse Jas 5:18 are delivered first, followed by the marginal references, and then the notes.

In a preferred embodiment, the API server 10 will only return content which overlaps the requested scope. Thus, in the example illustrated, if the client 12 requests content with a scope of James 5:13-18, notes which pertain, for example, to James 5:13-14, James 5:13-18, James 5:14, and James 5:16-19 would be retrieved, while notes which apply to James 5:13 or James 5:19029 would not be retrieved.

The system of the present invention may include at least one client computer with a user interface 12. The computer 12 may include any computer including, but not limited to, a desktop, laptop, and smart device, such as, a tablet and smart phone. The computer 12 includes a program product including a machine-readable program code for causing, when executed, the computer 12 to perform steps. The program product may include software which may either be loaded onto the computer or accessed by the computer. The loaded software may include an application on a smart device. The software may be accessed by the computer 12 using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer.

For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer 10 system that can be accessed by a plurality of client computer systems 12 interconnected over an intranet network, or that is accessible to clients over the Internet.

In addition, while presented in the context of Biblical works and scholarship, many embodiments of the present invention have application to a wide range of literary and technical scholarship and industries. To the extent the present application discloses a system, the method implemented by that system, as well as software stored on a non-transitory computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

1. A system for digitally researching, organizing and displaying data relating to a primary work, comprising:
a computer having a user interface; and
a program product comprising machine-readable program code for causing, when executed, the computer to perform the following process steps:
producing an electronic representation of a portion of the primary work in a first column of a display area responsive to a user specified scope;
producing an electronic representation of a note in a second column of the display area, the note corresponding to the portion of the primary work in the first column and organized according to a first category of rubrics;
producing an electronic representation of the note in a third column of the display area, the note corresponding to the portion of the primary work in the first column and organized according to a second and a third category of rubrics;
dynamically updating the electronic representation of the portion of the primary work responsive to a user specified change in the scope;
dynamically updating the electronic representation of the note responsive to the user specified change in scope.

2. The system of claim 1, further comprising:
producing an electronic representation of a marginal reference corresponding to the portion of the primary work in the first column, within an intertextual reference zone of the display area; and
dynamically updating the electronic representation of the marginal reference responsive to the user specified change in scope.

3. The system of claim 2, further comprising:
providing a control with the marginal reference operable to select a referenced portion of the primary work.

4. The system of claim 2, further comprising:
producing an electronic representation of a recommended reading zone presenting references corresponding to a selected rubric; and
dynamically updating the recommended reading zone responsive to the user specified change in scope.

5. The system of claim 1, wherein the electronic representation of the portion of the primary work is presented in a plurality of versions, wherein each version is designated by a visual indicia corresponding to each version.

6. The system of claim 5, wherein the visual indicia is a head letter.

7. The system of claim 1, wherein the note is prefaced with a citation to the portion of the primary work in the first column.

8. The system of claim 7, wherein the note further comprises a control operable to present an electronic representation of the note.

9. The system of claim 1, further comprising:
a control area having a plurality of controls for receiving a user input specifying the scope.

10. The system of claim 9, wherein the plurality of controls includes: a slider, a scroll direction control, a search window, and a menu indicator control.

11. The system of claim 10, further comprising:
a control operable in the control area to activate a content creation module, configured for a contributor to create one or more of a note, a synthetic note, or a marginal reference.

12. A non-transitory machine storage medium having stored thereon a computer program for digitally researching, organizing and displaying data relating to a primary work, the computer program comprising a set of instructions for causing the machine to perform the steps of:
producing an electronic representation of a portion of the primary work in a first column of a display area responsive to a user specified scope;
producing an electronic representation of a note in a second column of the display area, the note corresponding to the portion of the primary work in the first column and organized according to a first category of rubrics;
producing an electronic representation of the note in a third column of the display area, the note corresponding to the portion of the primary work in the first column and organized according to a second and a third category of rubrics;
dynamically updating the electronic representation of the portion of the primary work responsive to a user specified change in the scope;
dynamically updating the electronic representation of the note responsive to the user specified change in scope.

13. The storage medium of claim 12, further comprising:
producing an electronic representation of a marginal reference corresponding to the portion of the primary work in the first column, within the intertextual reference zone of the display area; and
dynamically updating the electronic representation of the marginal reference responsive to the user specified change in scope.

14. The storage medium of claim 13, further comprising:
providing a control with the marginal reference operable to select a referenced portion of the primary work.

15. The storage medium of claim 13, further comprising:
producing an electronic representation of a recommended reading zone presenting references corresponding to a selected rubric; and
dynamically updating the recommended reading zone responsive to the user specified change in scope.

16. The storage medium of claim 12, wherein the electronic representation of the portion of the primary work is presented in a plurality of versions, wherein each version is designated by a visual indicia corresponding to each version.

17. The storage medium of claim 12, wherein the note is prefaced with a citation to the portion of the primary work in the first column.

18. The system of claim 16, wherein the note further comprises a control operable to present an electronic representation of the note.
